(19) United States
(12) Patent Application Publication
(10) Pub. No.: US 2008/0231418 A1
(43) Pub. Date: Sep. 25, 2008

(54) Integrated Physical Unclonable Function (Puf) with Combined Sensor and Display

(75) Inventors: Willem Gerard Ophey, Eindhoven (NL); Boris Skoric, Eindhoven (NL); Pim Theo Tuyls, Eindhoven (NL); Antonius Hermanus Maria Akkermans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/090,414

(22) PCT Filed: Oct. 2, 2006
(86) PCT No.: PCT/IB2006/053580

§ 371 Date: Apr. 16, 2008

(30) Foreign Application Priority Data
Oct. 17, 2005 (EP) 05109654.3

(51) Int. Cl. H04L 9/32

(52) U.S. Cl. 340/5.85

(57) ABSTRACT

The present invention relates to a device (100, 200, 300) and a method for creating challenge-response pairs. A basic idea of the present invention is to create a challenge in the form of light emitted onto a light scattering element (103, 203), which light will be scattered in the light scattering element and detected as a response to the challenge by light detecting elements (105, 205). The light scattering element comprises a transmissive material which contains randomly distributed light scattering particles (104, 204), which scatter incident light such that a random speckle pattern is created and spread over the light detecting elements. This random pattern is detected by the light detecting elements, and is known as the response to the challenge (i.e. the light) that was supplied to the light scattering element. Hence, a challenge-response pair is created. Further, picture elements (109, 209) are included in the device in order to enable modification of the challenge created by a light source (101, 201) and supplied to the light scattering element. By activating picture elements and thereby modifying the challenge, one will also modify the response that corresponds to the modified challenge.

The present invention relates to a device and a method for creating challenge-response pairs.

A Physical Unclonable Function (PUF) is a structure used for creating a tamper-resistant environment in which parties may establish a shared secret. Typically, a proving party should prove access to the secret by providing the PUF with a challenge from which a unique and unpredictable response is created. This response is supplied to a verifying party such that it can be verified that the proving party actually has access to the secret. Of course, this proving/verifying procedure should be undertaken without revealing the secret, which typically involves encryption/decryption. A PUF can only be accessed via an algorithm that is inseparable from the PUF, and any attempt to by-pass or manipulate the algorithm will destroy the PUF. PUFs are e.g. implemented in tokens employed by users to authorize themselves and thus get access to certain services or devices. The token may for example comprise a smart card communicating by means of radio frequency signals or via a wired interface (such as USB) with the device to be accessed.

To this end, an optical PUF may be employed, which comprises a physical structure containing light scattering material arranged in such a manner that directions in which light is scattered are randomly distributed. When producing the light scattering material, which for instance comprises a thin film, particles, irregularities and any other scattering elements become randomly distributed in the film. Typically, the PUF is illuminated from an input side with a light source (e.g. a laser) and the light scattering material produces speckle patterns on an output side of the PUF which may be detected by means of a camera sensor. The randomness and uniqueness of the light scattering in this material is exploited to create challenge-response pairs and cryptographic key material to be used in authentication and identification schemes. The input (i.e. the challenge) to the optical PUF can e.g. be angle of incidence of the laser, focal distance or wavelength of the laser, a mask pattern blocking part of the laser beam, or any other change in laser beam wave front. The output (i.e. the response) of the optical PUF is the speckle pattern. The input-output pair is usually referred to as a challenge-response pair (CRP). Replicating an optical PUF is very difficult, since even if the exact location of the scattering elements are known, precise positioning of scattering elements in a replica is virtually impossible and very expensive to attain.

A disadvantage exists in prior art authentication/identification systems that employ optical PUFs where the light source and the camera sensor are integrated. As explained in the above, challenges produced by the light source are created by changing shape, position, phase and/or direction of the light beam emitted onto the PUF. Hence, the PUF must be aligned with respect to the light source and the sensor of the reader to create appropriate challenge-response pairs.

“Physical Random Functions” by Blaise L. P. Gassend, Mass. Institute of Technology, February 2003 discloses an optical PUF in which a light source and light sensors are integrated on a chip that is embedded in an irregular transparent medium, such as an epoxy wafer, and surrounded by reflecting material. Instead of mechanically moving a laser source over an epoxy wafer to create a challenge, a plurality of laser diodes is arranged on the chip, and depending on the challenge to be created, a combination of them is turned on and off. Preferably, in the disclosed optical PUF, a non-linear optical medium should be used so that the response in the form of the speckle pattern is not just the sum of the patterns that would be accomplished if each diode would be turned on individually.

If a linear optical medium is employed, the number of distinct nontrivial challenges is in the order of N², where N denotes the number of laser diodes. If the optical medium is non-linear, the number would is in the order of 2^{N}. Hence, a problem with the disclosed optical PUF is that a large number of expensive laser diodes are required to provide a sufficient number of nontrivial challenges.

An object of the present invention is to solve the above-mentioned problems and to provide a cost-effective way of creating multiple challenges that are processed in a physically unclonable function to create an optically detectable response to the respective challenge.

This object is accomplished by a device and a method for creating challenge-response pairs in accordance with independent claims attached hereto.

Preferred embodiments of the invention are defined by dependent claims.

In a first aspect of the invention, there is provided a device comprising a light source, a light scattering element, a plurality of picture elements and a plurality of light detecting elements. The light source is arranged to create a challenge by illuminating the light scattering element, and the light scattering element is arranged to scatter incident light on the light detecting elements. Further, at least one of the picture elements is arranged to be activated to modify the challenge by reflecting incident light such that the reflected light illuminates the light scattering element, and the light detecting elements are arranged to create a response to the modified challenge by detecting the light scattered on them.

In a second aspect of the invention, there is provided a method comprising the steps of creating a challenge by illuminating a light scattering element and activating at least one of a plurality of picture elements to modify the challenge by reflecting light incident on said at least one picture element such that the reflected light illuminates the light scattering element. Further the method comprises the step of creating a response to the modified challenge by detecting the light scattered by the light scattering element.

A basic idea of the present invention is to create a challenge in the form of light emitted onto a light scattering element, which light will be scattered in the light scattering element and detected as a response to the challenge by light detecting elements. A light source in the form of e.g. a laser diode is typically used to produce the light that is emitted onto the scattering element. The light which is incident on the scattering element is referred to as a challenge. The emitted light is scattered and spread across the light detecting elements, wherein a response to the challenge is sensed by the light detecting elements. The light scattering element comprises a transmissive material which contains randomly distributed light scattering particles or simply physical irregularities, which scatter incident light such that a random speckle pattern is created and spread over the light detecting elements. This random pattern is detected by the light detecting elements, and is known as the response to the challenge (i.e. the light) that was supplied to the light scattering element. Hence, a challenge-response pair is created.

Advantageously, the light source, a PUF in the form of the light scattering element and the light detecting elements are integrated on one single chip, which for instance utilizes a complementary metal oxide semiconductor (CMOS) technology. Further, picture elements are integrated on the chip in order to enable modification of the challenge created by the light source and supplied to the light scattering element. By modifying the challenge, one will also modify the response that corresponds to the modified challenge. Hence, by activating the picture elements, the light which is incident on them will be reflected towards the light scattering element, and a plurality of different challenge-response pairs may be created, as will be described in the following. Activating a picture element typically means that the picture element is addressed by means of row and column signals, since the picture elements in general is arranged in a matrix-like structure. When the picture element has been addressed, a voltage is applied to it such that it is set in an intended optical state. Thus, the picture element displays the grayscale, color, luminance, etc, that is intended with the applied voltage.

When the picture elements are exposed to light (either directly from the light source or via the scattering element), light beams will be reflected at the activated picture elements and undergo a phase change (or a change in polarization state). By arranging the picture elements such that they can be set in a great umber of optical states, the phase of the light appears to change in a continuous manner as compared to a situation where the picture elements are switched between an off-state and an on-state. The reflected light will incide on the light scattering element. Hence, the light which is incident on the scattering element from the light source—the challenge—is modified by the light reflected at the picture elements and a new, modified challenge is created and input to the scattering element. The light scattering element scatters incident light such that a random speckle pattern is created and spread over the light detecting elements. This random pattern is detected by the light detecting elements, and a response to the modified challenge is thus created. Thus, the picture elements comprised in the chip will act as a phase or polarization modulator for incident light, which has as an effect that the light which is supplied to the scattering element is modified. Typically, the degree of modification of the challenge is dependent on the number of activated picture elements, as well as actual combination(s) of activated picture elements. A great number of activated picture elements will result in a high degree of challenge modification as well an increase of challenge space. Each new challenge provided to the light scattering element will result in a different speckle pattern for the light which illuminates the light detecting elements. Consequently, each new combination of activated picture elements will render a new, modified challenge and a corresponding new response. A new challenge-response pair is thus created.

Generally, the picture elements and the light detecting elements are arranged on the semiconductor wafer of the chip. On top of the picture elements and the light detecting elements, a liquid crystal (LC) layer is arranged and on top of the LC layer, a cover layer is arranged. On top of the cover layer, the light scattering element is positioned. Note that the cover layer may be an integral part of the light scattering element. The light source is arranged on the chip such that its light beams may be emitted into the light scattering element. Possibly, the light source is arranged underneath the light scattering element, in which case a light-coupling mechanism, e.g. a small mirror, may have to be used to couple the light into the light scattering element.

In this manner, the PUF (i.e. the light scattering element) and the PUF reader (i.e. the light source and the light detecting elements) are combined in one single, compact device. Further, by integrating a display comprising a plurality of picture elements (preferably arranged in a matrix), the possible number of challenge-response pairs that can be produced will increase greatly, as has been described in the above.

In embodiments of the present invention, the picture elements are arranged such that they either are interspersed with the light detecting elements, or arranged in a group which is physically separated from the light detecting elements.

In an embodiment of the invention, the light scattering element is arranged such that it scatters light of the light source on the picture elements. The light source, e.g. a laser diode, emits a diverging light beam which essentially is collimated by the light scattering element. The light scattering element scatters incident light on the light detecting elements as well as on the picture elements. Light incident on the picture elements will be reflected and undergo a phase change, or a change in polarization state, in accordance with the optical state of the picture elements. As previously described, the optical state of the picture element is determined by the voltage applied to it. The reflected light will fall on the scattering element and again illuminate the picture elements and the light detecting elements. The amount of light that will be reflected will gradually decrease because of scatter and absorption losses. When equilibrium is reached, the light on the detectors is the “coherent” sum of all successive light contributions. Hence, by activating picture elements and thereby modifying the challenge, residual light distribution (i.e. the response to the modified challenge) on the light detecting elements) is modified.

In another embodiment of the invention, light of the light source is arranged to fall directly on the picture elements. Light incident on the picture elements will be reflected and undergo a phase change, or a change in polarization state, in accordance with the optical state of the picture elements. The reflected light will fall on the scattering element and spread over the light detecting elements. In this particular embodiment, there are in principle no multiple reflections between the picture elements and the light scattering element.

According to further advantageous embodiments, the inventive device described hereinabove is employed in authentication systems, at enrollment as well as at actual authentication.

Further features of, and advantages with, the present invention will become apparent when studying the appended claims and the following description. Those skilled in the art realize that different features of the present invention can be combined to create embodiments other than those described in the following.

A detailed description of preferred embodiments of the present invention will be given in the following with reference made to the accompanying drawings, in which:

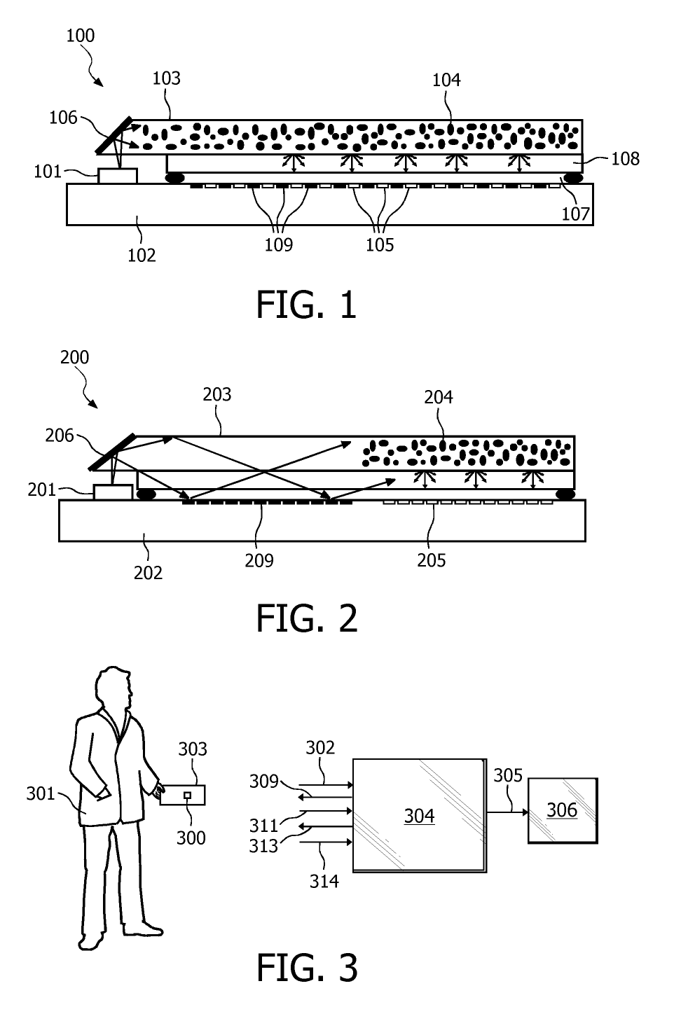

FIG. 1 shows a cross-sectional side view of a device for creating challenge-response pairs according to an embodiment of the present invention.

FIG. 2 shows a cross-sectional side view of a device for creating challenge-response pairs according to another embodiment of the present invention.

FIG. 3 shows an authentication system in which any one of the devices of FIG. 1 and 2 advantageously may be employed to securely authenticate a user at a verifier.

FIG. 1 shows a cross-sectional side view of a device 100 for creating challenge-response pairs according to an embodiment of the present invention. A laser diode 101 is arranged on a CMOS light sensor/display chip 102. The laser diode is arranged to emit light into a light scattering element 103 which is a light transmissive material which contains randomly distributed light scattering particles 104 such that light incident on the scattering element is randomly scattered onto a plurality of light detectors 105. The laser beam of the laser diode is typically coupled into the scattering element by means of a light coupler 106, such as a mirror or a facet of the light scattering element. Hence, the light scattering element is provided with a challenge in the form of light emitted by the laser diode.

The light scattered by the light scattering element is spread across the light detectors 105 via an LC layer 107 in case LCD technology is used. Preferably, a protective glass cover-plate 108 is employed. This cover-plate may be integrated with the scattering element. The random light pattern scattered on the light detectors represents the response to the challenge created by the laser diode 101.

In this particular embodiment, picture elements 109 are interspersed with the light detectors 105. By activating one or more of these the picture elements, the light which is incident on them via the light scattering element 103 will be reflected in direction of the scattering element. Now, the scattering element will not only be provided with direct light from the laser diode 101, but also with light reflected at the activated picture elements. Hence, the activation of the picture elements causes a change in the light which is input to the scattering element. This will bring about a change in the random speckle pattern created by the light scattering element 103 and spread over the light detectors 105. Consequently, modification of the challenge by means of activating picture elements causes a change in the response detected by the light detectors. Hence, new challenge-response pairs may be created by means of controlling the picture elements.

FIG. 2 shows a cross-sectional side view of a device 200 for creating challenge-response pairs according to another embodiment of the present invention. A laser diode 201 is arranged on a CMOS light sensor/display chip 202. The laser diode is arranged to emit light via a light coupling element 206 into a light scattering element 203 which contains randomly distributed light scattering particles 204 such that light incident on the scattering element is randomly scattered onto a plurality of light detectors 205. In this particular embodiment of the invention, picture elements 209 are separated from the light detectors 205 creating a picture element section and a light detector section for the device 200. The scattering particles 204 are arranged at the light detector section of the device, while there are no scattering particles arranged at the picture element section. Hence, in this embodiment, the light which falls on the picture elements 209 is in substance direct light from the laser diode 201.

Again, by activating one or more of these picture elements, the light which is incident on them will be reflected towards the scattering element 203. The scattering element will not only be provided with direct light from the laser diode 201, but also with light reflected at the activated picture elements. Hence, the activation of the picture elements causes a change in the light which is input to the scattering element. This will bring about a change in the random speckle pattern created by the light scattering element 203 and spread over the light detectors 205. Consequently, modification of the challenge by means of activating picture elements causes a change in the response detected by the light detectors. Hence, new challenge-response pairs may be created by means of controlling the picture elements.

In FIG. 1 and 2, it should be noted that each light scattering element 103, 203 acts as a PUF. However, it is only the part of the scattering element which is arranged with scattering particles 104, 204 that is considered to provide random scatter functionality. Thus, in FIG. 2, only a part the scattering element 203 provides PUF operation. It is also possible to include a plurality of light scattering elements in the device 100, 200. It is then possible to intersperse picture elements, light detecting elements and light scattering elements to create an even greater challenge space.

As shown in FIG. 3, the present invention may advantageously be employed to securely authenticate a user 301 at a verifier. A device 300 for generating CRPs in accordance with the present invention, which has been described hereinabove, may be implemented in a token to which the user has access, for instance a smartcard, a USB stick, a mobile phone SIM card, etc. The token, hereinafter exemplified in the form of a USB stick 303, is interfaced with an appropriate device of the verifier. For instance, a USB stick of the user is inserted (step 302) into a computer 304 at which the user seeks authentication. In the following authentication procedure, it is assumed that the memory stick further comprises a public key pk of a verifier and a random number generator.

The USB stick 303 typically comprises a microprocessor (not shown), or some other appropriate device having computing possibilities, in order to perform cryptographic operations and other computing operations. The microprocessor execute appropriate software that is downloaded to the compliant device and stored in a memory such as a RAM.

First, the verifier acquires (step 305) a challenge-response pair C, R(C). The acquiring of the challenge-response pair may be effected by fetching the pair from a database stored in a memory 306 at the verifier. Possibly, the challenge-response pair may be identified in the database, which typically comprises a number of challenge-response pairs, by means of the user sending the verifier his or her identity ID prior to the acquiring, wherein the verifier may fetch the challenge-response pair for this particular user.

Thereafter, the challenge C is distributed (step 309) to the USB stick of the user, which stick comprises a device 300 as embodied in FIG. 1 or 2. With reference to FIG. 1 and 2, the device comprises an optical PUF in the form of the light scattering element 103, 203, and the picture elements 109, 209 are activated in such a manner that the challenge created by the laser diode 101, 201 and the picture elements, i.e. what is referred to hereinabove as the modified challenge, represents the challenge C which was sent to the USB stick by the verifier. Note that the verifier typically sends digital data to the USB stick, wherein the digital data is converted into operating parameters of the picture elements. Hence, the digital data results in a predetermined optical state of the picture elements. Now, the light scattering elements processes the challenge to create a first estimate R′(C) of the response. The estimate R′(C) is represented by the random speckle pattern produced by the light scattering element on the light detectors 105, 205. This random pattern is detected and converted into an appropriate digital signal by the USB stick.

In general, this first estimate can be viewed upon as a noise-contaminated copy of the true response R(C) held by the verifier. This noise may be eliminated by creating a second estimate S′ of the response by means of using the first estimate R′(C) and a set of helper data W associated with the challenge-response pair C, R(C). The helper data W may either be stored at the USB stick or sent from the verifier to the USB stick along with the challenge C.

In this exemplifying authentication procedure, a helper data scheme (HDS) is employed, in which secret data S and helper data W are derived from the response R(C) to the challenge C. The data S is secret to avoid response-revealing attacks on the response by analysis of S. The secret data S is subsequently used at the verifier, as will be described hereinafter. Both the USB stick 303 employed by the user 301 and the device 304 of the verifier with which the user requests authorization are preferably secure, tamper-proof and hence trusted by the user. The helper data W is typically calculated at the verifier (but may be stored at the USB stick) such that S=G(R(C), W), where G is a delta-contracting function. Hence, as W is calculated from the response R(C) and the secret data S, G( ) allows the calculation of an inverse W=G⁻¹(R(C), S). This calculation is typically performed during what is referred to as an enrollment phase at the verifier. This particular scheme is further described in “New Shielding functions to prevent misuse and enhance privacy of biometric templates” by J. P. Linnartz and P. Tuyls, AVBPA 2003, LNCS 2688. During the enrollment phase, the verifier gathers reference data pertaining to the user in the form of challenge-response pair(s) for the PUF of the user. The reference data are stored such that it subsequently may be used during a verification phase.

Noise-robustness is provided by calculating, in the verification phase (i.e. the phase in which authentication actually is requested), the second estimate S′ at the USB stick as S′=G(R′(C), W). The delta-contracting function has the characteristic that it allows the choice of an appropriate value of the helper data W such that S′=S, if the first estimate R′(C) sufficiently resembles the response R(C).

Now, a random number RAN is generated at the USB stick and encrypted with the public key pk of the verifier. The result Eₚₖ(RAN) is sent (step 311) to the verifier. The USB stick uses the second estimate S′ and the random number RAN to derive a unique key S′_{RAN}. The verifier derives the secret data S by means of using the response R(C) obtained in the enrollment phase, such that S=G(R(C), W). Further, the verifier decrypts Eₚₖ(RAN) such that a clear text copy of the random number RAN is attained and derives a unique key S_{RAN}. Then, the verifier sends (step 313) a message m to the USB stick, whereupon the USB stick encrypts the message m with the unique key S′_{RAN}. This encrypted message is sent (step 314) to the verifier, which decrypts the message to check that it is identical to the message sent from the verifier to the USB stick. If so, the user of the optical PUF comprised in the USB stick is granted authorization, since there is a match between the noise-robust, second estimate S′ derived during the verification phase and the secret data S derived in the enrollment phase.

Clearly, the different embodiments of the device 100, 200 described in the above in connection to FIG. 1 and 2 may advantageously be employed in an authentication system as described in connection to FIG. 3. In particular, the device 100, 200 is advantageous during enrollment, since a great number of challenge-response pairs can be produced in a relatively straightforward manner. At enrollment, a plurality of challenge-response pairs may be created and stored at a party at which authentication subsequently is required. Please note that the particular authentication procedure described in connection to FIG. 3 merely is exemplifying, and that other ways of performing the authentication procedure is known in the art.

In the detailed description of preferred embodiments of the present invention hereinabove, liquid crystal picture elements are employed. However, other technologies may alternatively be employed, such as micro-electromechanical system (MEMS) optical switches. In the case MEMS picture elements are employed, no LC layer (or cover glass) is required. Further, when employing LC technology, the cover glass should be provided with a transparent conducting layer, which is provided with a (constant) voltage.

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. A device for creating challenge-response pairs comprising:
a light source;
a light scattering element;
a plurality of picture elements; and
a plurality of light detecting elements;
wherein the light source is arranged to create a challenge by illuminating the light scattering element,
the light scattering element is arranged to scatter incident light on the light detecting elements,
at least one of the picture elements is arranged to be activated to modify the challenge by reflecting incident light such that the reflected light illuminates the light scattering element, and
the light detecting elements are arranged to create a response to the modified challenge by detecting the light scattered on them.

2. The device according to claim 1, further comprising a chip for integrating the light source, the light scattering element, the picture elements and the light detecting elements.

3. The device according to claim 2, wherein the chip is a CMOS technology integrated circuit.

4. The device according to claim 1, wherein the picture elements are interspersed with the light detecting elements.

5. The device according to claim 1, wherein the picture elements are arranged in a group which is physically separated from the light detecting elements.

6. The device according to claim 1, further comprising a light coupling element for coupling a light beam of the light source into the light scattering element.

7. The device according to claim 1, wherein the light scattering element scatters light on the picture elements (109).

8. The device according to claim 1, wherein light of the light source falls directly on the picture elements.

9. The device according to claim 1, wherein the picture elements and light detecting elements are arranged in the same plane.

10. The device according to claim 1, further comprising a liquid crystal layer arranged on the picture elements.

11. The device according to claim 1, wherein the picture elements include MEMS picture elements.

12. A method of creating challenge-response pairs comprising:
creating a challenge by illuminating a light scattering elements;
activating at least one of a plurality of picture elements to modify the challenge by reflecting light incident on said at least one picture element such that the reflected light illuminates the light scattering element; and
creating a response to the modified challenge by detecting the light scattered by the light scattering element.

13. The method of claim 12, wherein creating a response further comprises detecting the scattered light with light detecting elements.

14. The method according to claim 12, wherein creating a challenge further comprises coupling a light beam of a light source into the light scattering element.

15. The method according to claim 12, further comprising scattering light of the light source on the picture elements.

16. (canceled)

17. (canceled)

18. (canceled)

19. (canceled)

20. A computer program embodied on a computer-readable medium comprising a computer-executable code for causing the acts comprising:
creating a challenge by illuminating a light scattering element;
activating at least one of a plurality of picture elements to modify the challenge by reflecting light incident on said at least one picture element such that the reflected light, illuminates the light scattering element; and creating a response to the modified challenge by detecting the light scattered by the light scattering element.
